(19) United States
(12) Patent Application Publication
(10) Pub. No.: US 2010/0245771 A1
(43) Pub. Date: Sep. 30, 2010

(54) POLARIZATION CONVERSION ASSEMBLY AND SINGLE-IMAGER MICRO PROJECTION ENGINE

(75) Inventor: HERB HE HUANG, SHANGHAI (CN)

Correspondence Address: J C PATENTS, 4 VENTURE, SUITE 250, IRVINE, CA, 92618, US

(73) Assignee: JIANGSU LEXVU ELECTRONICS CO., LTD., JIANGSU (CN)

(21) Appl. No.: 12/732,022

(22) Filed: Mar. 25, 2010

Related U.S. Application Data
(60) Provisional application No. 61/163,835, filed on Mar. 26, 2009.

(51) Int. Cl. G03B 21/14; G02B 27/28

(52) U.S. Cl. 353/20; 359/495; 359/486

(57) ABSTRACT

A single-imager micro projection engine includes a reflective polarization modulation imager, a projection lens system and a polarization conversion assembly integrating a light source with a planar polarization beam splitter and a reflective quarter wave composite plate in parallel. The polarization conversion assembly lets through first polarization portion of illumination light in first polarization state from the light source for illuminating a first half facing area on the reflective polarization modulation imager, while reflecting second portion in second polarization state perpendicular to first polarization state towards the reflective quarter wave composite plate. The reflective quarter wave composite plate reflects, while 90-degree polarization rotating from second polarization state to first, the received second portion back to the planar polarization beam splitter. The reflected and polarization-rotated second portion also in first polarization state transmits through the planar polarization beam splitter and illuminates a second half facing area on the reflective polarization modulation imager. Modulated and 90-degree polarization-rotated images produced by both the first and second half facing areas of the reflective polarization imager are reflected by the planar polarization beam splitter towards the projection lens towards an external projection screen.

### CROSS-REFERENCE TO RELATED APPLICATIONS

This application claims priority of provisional application No. 61/163,835, filed on Mar. 26, 2009, entitled “Single-Imager Micro Projection Engine”, which is incorporated herein by reference in its entirety.

### FIELD OF THE TECHNOLOGY

The present invention is related to microdisplay projection systems, and more particularly to a polarization conversion assembly and a single-imager micro projection engine.

### BACKGROUND

Microdisplay projection systems employ a transmissive or a reflective microdisplay imager, commonly referred to as a light valve or light valve array, which imposes an image on an illumination light beam. One of the advantages on reflective light valves over transmissive light valves is that reflective light valves permit controlling circuitry to be placed in situ behind the reflective surface, and more advanced integrated circuit technology is available because the substrate materials are not limited by their opaqueness.

Reflective liquid-crystal-on-silicon (LCOS) imagers rotate while modulating the polarization of incident light. Thus, polarized light is either reflected by the LCOS imager with its polarization state substantially unmodified, or with a degree of polarization rotation imparted to provide a desired grey scale. Accordingly, a polarized light beam is generally used as the input beam for reflective LCOS imagers, while a polarizing beam-splitter (PBS) is employed for splitting the incoming light beam to two polarized light beams in orthogonal polarization states.

Widely used for various portable and handheld micro projection display applications, a single-imager projection engine employs one LCOS modulation imager and one PBS. One of the drawbacks of this optical projection engine is that only limited portion of illumination light in one polarization state is used for illuminating the reflective polarization modulation imager and therefore, after modulation and reflection by the reflective polarization modulation imager, total illumination projected through a projection lens system onto a projection screen is limited.

### SUMMARY

In an embodiment of the present invention, a single-imager micro projection engine includes a reflective polarization modulation imager, a projection lens system and a polarization conversion assembly integrating a light source with a planar polarization beam splitter and a reflective quarter wave composite plate in parallel. The polarization conversion assembly lets through first polarization portion of illumination light in first polarization state from the light source for illuminating a first half facing area on the reflective polarization modulation imager, while reflecting second portion in second polarization state perpendicular to first polarization state towards the reflective quarter wave composite plate. The reflective quarter wave composite plate reflects, while 90-degree polarization rotating from second polarization state to first, the received second portion back to the planar polarization beam splitter. The reflected and polarization-rotated second portion also in first polarization state transmits through the planar polarization beam splitter and illuminates a second half facing area on the reflective polarization modulation imager. Modulated and 90-degree polarization-rotated images produced by both the first and second half facing areas of the reflective polarization imager are reflected by the planar polarization beam splitter towards a projection lens system and an external projection screen. Thus, substantial portions of illumination light in both polarization states are utilized for illuminating the reflective polarization imager and thus, for producing projection display through the projection lens system in a compact but efficient micro projection engine configuration.

In another embodiment of the present invention, the single-imager micro projection engine incorporates an LCOS imager as the reflective polarization modulation imager. Another extended embodiment instead incorporates a micro electrical-mechanical diffractive pixel array device, or grating light valve (GLV) array device with a second transmissive quarter wave plate as the equivalent reflective polarization modulation imager.

### BRIEF DESCRIPTION OF THE DRAWINGS

The disclosure may be more completely understood in consideration of the following detailed description of various embodiments in connection with the accompanying drawings, in which:

FIG. 1 illustrates a cross section view of a polarization conversion assembly in an embodiment of the present invention.

FIG. 2 illustrates a cross section view of a single-imager micro projection engine which incorporates the polarization conversion assembly in the embodiment of the present invention.

FIG. 3 illustrates a cross section view of the single-imager micro projection engine including a means in another embodiment of the present invention.

FIGS. 4 and 4a illustrate cross section views of a single-imager micro projection engine incorporating an imaging polarization beam splitter in another embodiment of the present invention.

FIG. 5 illustrates a cross section view of a constituent reflective polarization modulation imager.

FIG. 6 illustrates a cross section view of the polarization conversion assembly in another embodiment of the present invention.

### DETAILED DESCRIPTION

The present invention is widely applicable to various microdisplay projection systems. In particular, this disclosure is related to single-imager micro projection engines employing a light source, a reflective polarization modulation imager, a planar polarization beam splitter and a reflective quarter wave composite plate in parallel, and a projection lens system which are configured for providing dramatically improved optical efficiency in micro projection display. While the present invention is not so limited, an appreciation of various aspects of the disclosure will be gained through a discussion of the examples provided below.

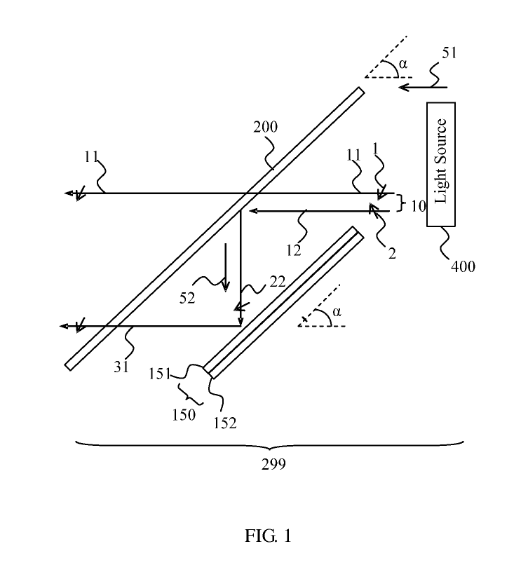

FIG. 1 illustrates a cross section view of a polarization conversion assembly 299 in an embodiment of the present invention. The polarization conversion assembly 299 includes a light source 400, a planar polarization beam splitter 200 and a reflective quarter wave composite plate 150 in parallel with the planar polarization beam splitter 200. As illustrated in FIG. 1, the light source 400 emits collimated illumination beam 10 along a first direction 51, which includes a first polarization portion 11 in first polarization state 1 and a second polarization portion 12 in second polarization state 2 orthogonal to first polarization state 1, towards the planar polarization beam splitter 200 along the first direction 51. Set in an included facing angle α, substantially close to 45 degree with the first direction 51 and the collimated illumination beam 10, the planar polarization beam splitter 200 is configured for substantially transmitting the first polarization portion 11 in first polarization state 1 and substantially reflecting the second polarization portion 12 in second polarization state 2 as reflected second polarization portion 22 in a second direction 52 perpendicular to the first direction 51.

The reflected second polarization portion 22 in second polarization state 2 in the second direction 52 is then received by the reflective quarter wave composite plate 150, adequately configured in parallel to the planar polarization beam splitter 200 and including a first transmissive quarter wave plate 151 for receiving the reflected second polarization portion 22 in second polarization state 2, and a mirror plate 152. As eventually reflected by the mirror plate 152, the received reflected second polarization portion 22 initially in second polarization state 2 passes through the first transmissive quarter wave plate 151 twice and thus is polarization rotated by 90-degree as a converted second polarization portion 31 reflected back in first polarization state 1 with the first polarization portion 11, both along the first direction 51.

The planar polarization beam splitter 200 is either a multilayer polarizing beam splitting film or a wire grid polarizing plate. The quarter wave plate 151 and the mirror plate 152 in parallel may be adhered into a stacking composite configuration for constructing the reflective quarter wave composite plate 150.

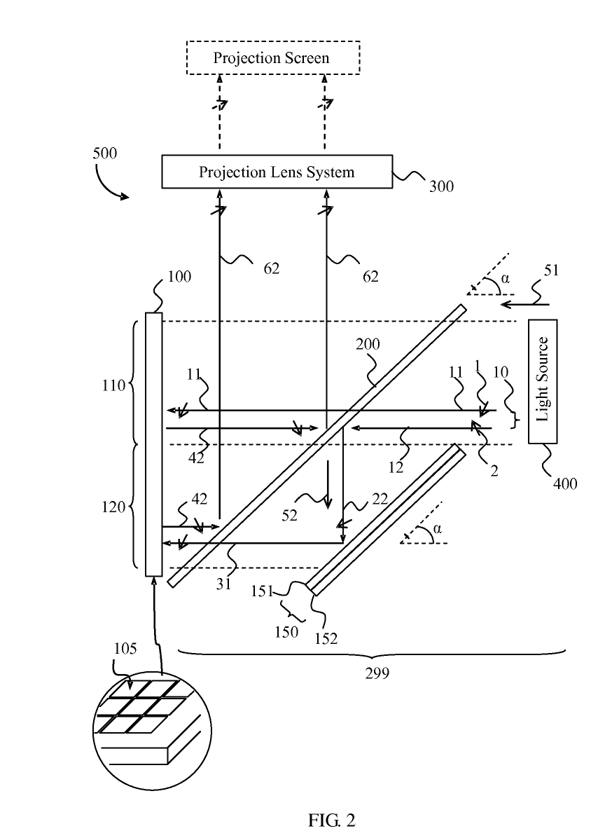

FIG. 2 illustrates a cross section view of a single-imager micro projection engine 500 which incorporates the polarization conversion assembly 299 in the embodiment of the present invention. As illustrated, the first polarization portion 11 in first polarization state 1, which transmits through the planar polarization beam splitter 200, is received by the first half facing area 110 of the reflective polarization modulation imager 100. Meanwhile, the converted second polarization portion 31 in first polarization state 1 also transmits through the planar polarization beam splitter 200 and illuminates a second half facing area 120 of the reflective polarization modulation imager 100.

Both receiving illumination in first polarization state 1, the first half facing area 110 and the second half facing area 120, appropriately connected at edges, of the reflective polarization modulation imager 100, jointly provide images, through its constituent reflective modulation-imager pixels 105, in a modulated illumination of continued images 42 in second polarization state 2, being reflected towards the planar polarization beam splitter 200. Then, the modulated illumination of continued images 42 are reflected again by the planar polarization beam splitter 200, as a projection illumination of continued images 62 still in second polarization state 2, and led through the projection lens system 300 and eventually, onto a projection screen outside the single-imager micro projection engine 500, as illustrated in FIG. 2.

In an embodiment of the present invention, a liquid crystal on silicon imager may be used as the reflective polarization modulation imager 100, including a plurality of modulation imager pixels 105 in a regularly tiled planar arrangement.

The reflective quarter wave composite plate 150 may be composed of a first transmissive quarter wave plate 151 and a mirror plate 152 in parallel from front to back facing the planar polarization beam splitter 200. Those two component plates 151 and 152 are selectively adhered into a stacking composite configuration.

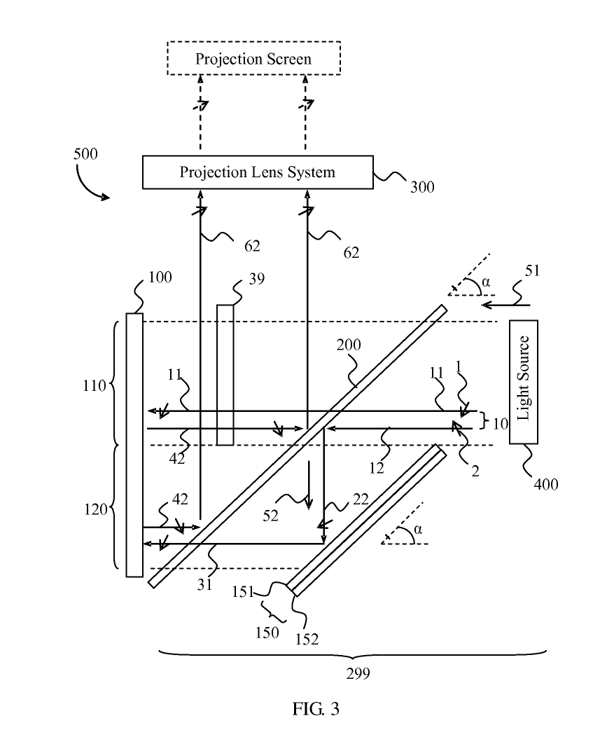

FIG. 3 illustrates a cross section view of the single-imager micro projection engine 500 including means 39 for balancing difference in received polarization illumination between the first half facing area 110 and the second half facing area 120 of the reflective polarization modulation imager 100, in another embodiment of the present invention. Though polarized illumination components of the collimated illumination beam 10 in both orthogonal states are utilized at improved percentage in this configuration, there would be certain difference in brightness or intensity between the illuminations received by the first half facing area 110 and the second half facing area 120 of the reflective polarization modulation imager 100. Particularly, the second polarization portion 12 in second polarization state 2 would go through longer optical path and more optical components than the first polarization portion 11 in first polarization state 1, before reaching the reflective polarization modulation imager 100. Thus, means 39 for adjusting and balancing the overall brightness between the first polarization portion 11 received by the first half facing area 110 and the converted second polarization portion 31 by the second half facing area 120 become necessary. Such means 39 is adapted, but not limited to: 1) to electrically instruct the reflective polarization modulation imager 100, upon measuring and calibrating, to adjust the light output between the two half facing areas; 2) to apply optical compensation, particularly light deduction to the first half facing area 110; 3) to purposely reduce the intensity of the first polarization portion 11 of collimated illumination beam 10 in first polarization state 1 before applying the optical compensation to the first half facing area 110 of the reflective polarization modulation imager 100.

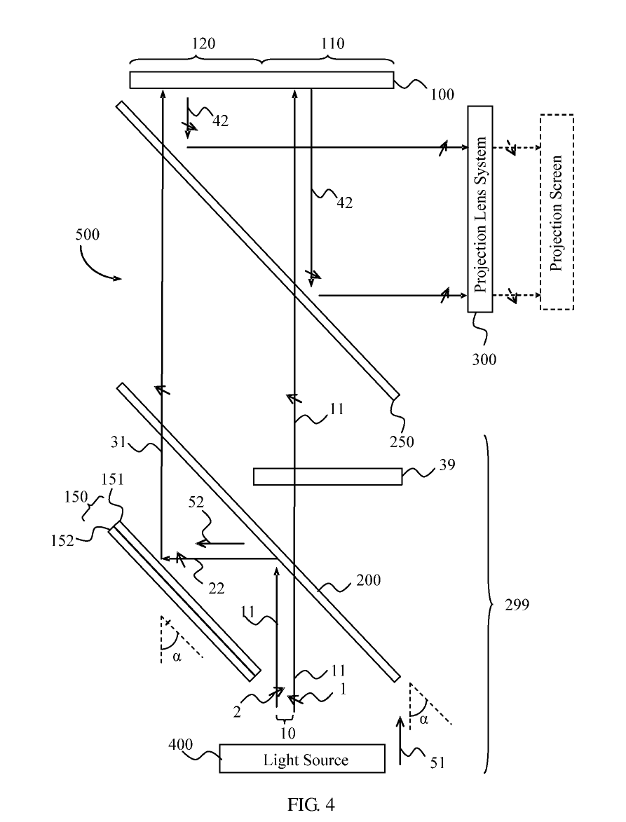

FIG. 4 illustrates a cross section view of a single-imager micro projection engine 500 incorporating the polarization conversion assembly 299 with a reflective polarization modulation imager 100, a projection lens system 300 and an imaging polarization beam splitter 250 in another embodiment of the present invention. In this embodiment, the polarization conversion assembly 299 projects substantially polarized and collimated illumination in first polarization state 1, including the first polarization portion 11 and the converted second polarization portion 31, to the imaging polarization beam splitter 250. The imaging polarization beam splitter 250 transmits the first polarization portion 11 and the converted second polarization portion 31 to the reflective polarization modulation imager 100, and reflect the modulated illumination of continued images 42 in second polarization state 2 from the reflective polarization modulation imager 100 to the projection lens system300.

The single-imager micro projection engine 500 incorporating the polarization conversion assembly 299 as shown in FIG. 4 thus can utilize substantial portion of both the first polarization portion 11 in first polarization state 1 and the second polarization portion 12 in second polarization state 2 of the collimated illumination beam 10, so as to improve the total illumination projected through the projection lens system 300 onto the projection screen after modulation and reflection by the reflective polarization modulation imager 100 and provide dramatically improved optical efficiency in various micro projection display systems.

Similar to the planar polarization beam splitter 200, the imaging polarization beam splitter 250 is either a multilayer polarizing beam splitting film or a wire grid polarizing plate.

Although the imaging polarization beam splitter 250 is drawn in parallel to the planar polarization beam splitter 200 in the polarization conversion assembly 299, the imaging polarization beam splitter 250 may also be configured perpendicular being rotated by 90-degree in another extended valid configuration, while the reflective polarization modulation imager 100 is then placed opposite to the projection lens system 300 to the imaging polarization beam splitter 250, as shown in FIG. 4a.

Besides, in another embodiment of the present invention, the polarization conversion assembly 299 is valid for providing the similar polarization and polarization conversion function as described, using a shorter version of the planar polarization beam splitter 200 as shown in FIG. 4a. Herein portion of the entire converted second polarization portion 31 directly emits from the polarization conversion assembly 299 to the imaging polarization beam splitter 250 without passing through the planar polarization beam splitter 200.

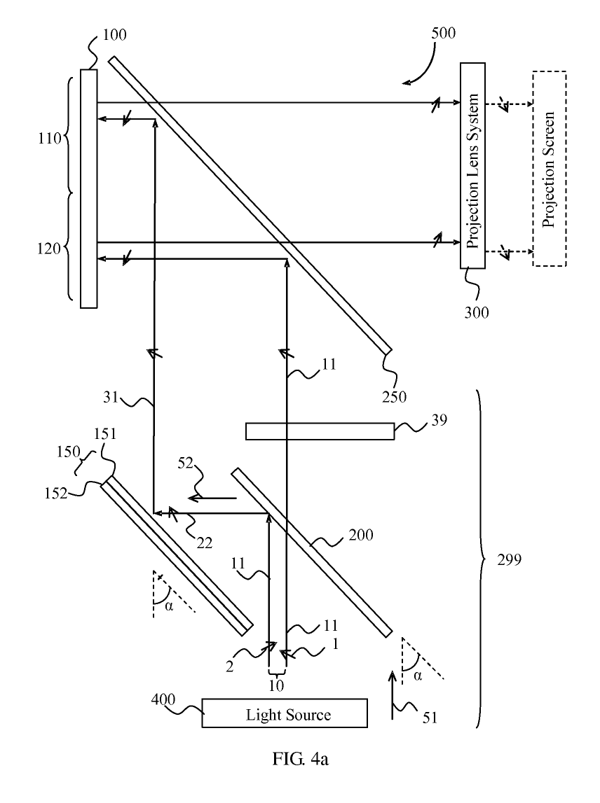

FIG. 5 illustrates a cross section view of a constituent reflective polarization modulation imager 100 in another embodiment of the present invention. In the embodiments as shown in FIGS. 2, 3, 4 and 4a, a liquid crystal on silicon imager may be employed as the reflective polarization modulation imager 100, providing the needed spatial light modulation and reflection with 90-degree polarization rotation. Alternatively, in the embodiment as shown in FIG. 5, a reflective polarization modulation imager 100 including a second transmissive quarter wave plate 130 and a reflective intensity modulation imager panel 140 suffices the requirements as shown in FIG. 4. Optionally, the reflective intensity modulation imager panel 140 may include a micro electrical-mechanical diffractive pixel array or a GLV array in a regularly tiled planar arrangement.

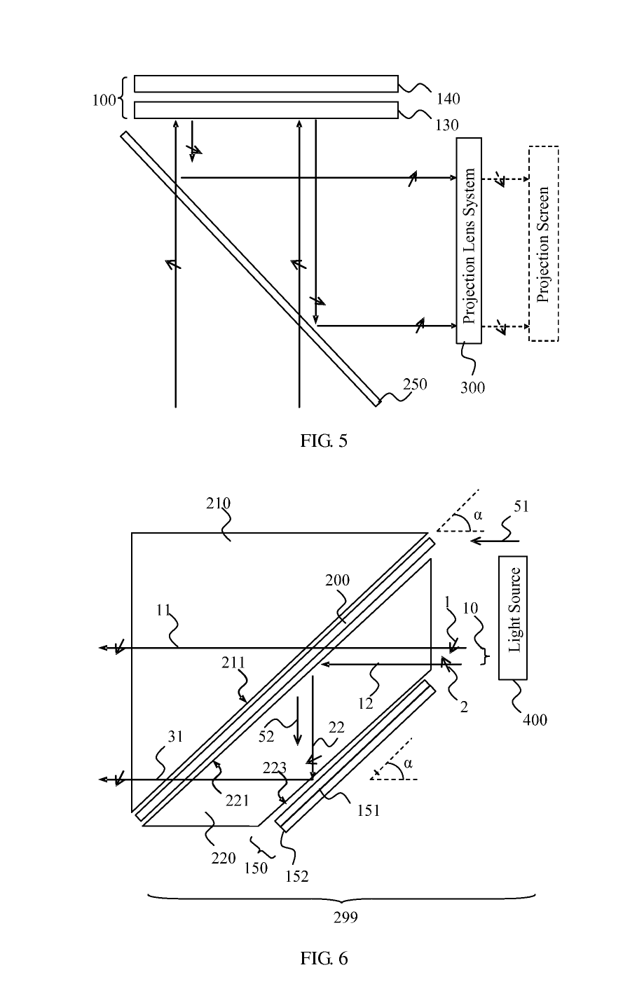

FIG. 6 illustrates a cross section view of the polarization conversion assembly 299 in another embodiment of the present invention, particularly with the improved mechanical and optical architecture for assembling the constituent components of the polarization conversion assembly 299. First, the planar polarization beam splitter 200 adherently sandwiched by a first side-face 211 of a transparent triangular prism 210 and a first side-face 221 of a transparent four-side polygon 220. Secondly, the reflective quarter wave composite plate 150 is adhered to a second side-face 223 opposite and parallel to the first side-face 221 of the transparent four-side polygon 220 of the planar polarization beam splitter 200. Optionally, the transparent triangular prism 210 and the transparent four-side polygon 220 are made from any one or combination of glasses, silicone and solid transparent organic materials including but not limited to polycarbonates and Poly(methyl methacrylate) (PMMA).

The light source 400 employed in the polarization conversion assembly 299 may be generated by any one or combination of arc lamps, tungsten lamps, halide lamps and the alike, and alternatives such as electromagnetic ballast, light emitting diodes and lasers.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A polarization conversion assembly, comprising:
a light source adapted to induce a collimated illumination beam forwards along a first direction;
a planar polarization beam splitter configured in an included facing angle α close to 45 degree with the first direction, and adapted to transmit a first polarization portion of the collimated illumination beam in first polarization state and reflect a second polarization portion of the collimated illumination beam in second polarization state perpendicular to first polarization state as a reflected second polarization portion in second polarization state along a second direction perpendicular to the first direction; and
a reflective quarter wave composite plate configured in parallel to and facing the planar polarization beam splitter forwards along the first direction, and adapted to reflect while polarization rotating by 90-degree from second polarization state to first polarization state, the reflected second polarization portion as a converted second polarization portion in first polarization state along the first direction.

2. The polarization conversion assembly according to claim 1, wherein the planar polarization beam splitter is adherently sandwiched between a first side-face of a transparent triangular prism and a first side-face of a transparent four-side polygon.

3. The polarization conversion assembly according to claim 2, wherein the reflective quarter wave composite plate is adhered to a second side-face opposite and parallel to the first side-face of the transparent four-side polygon.

4. The polarization conversion assembly according to claim 2, wherein the transparent triangular prism and the transparent four-side polygon are made from any one or combination of glasses, silicone and solid transparent organic materials comprising polycarbonates and PMMA.

5. The polarization conversion assembly according to claim 1, wherein the light source is generated by any one or combination of arc lamps, tungsten lamps, halide lamps, electromagnetic ballast, light emitting diodes and lasers.

6. The polarization conversion assembly according to claim 1, wherein the planar polarization beam splitter is either a multilayer polarizing beam splitting film or a wire grid polarizing plate.

7. A single-imager micro projection engine, comprising:
the polarization conversion assembly of the claim 1;
a reflective polarization modulation imager comprising a plurality of reflective modulation-imager pixels in a regularly tiled planar arrangement perpendicular to the collimated illumination beam, facing the planar polarization beam splitter opposite to the light source, and adapted to receive q first polarization portion in first polarization state and a converted second polarization portion in first polarization state, and provide a modulated illumination of continued images in second polarization state; and
a projection lens system configured opposite to the reflective quarter wave composite plate relative to the planar polarization beam splitter, and adapted to allow the projection illumination of continued images which is formed after the polarization conversion assembly reflects the modulated illumination of continued images to lead through the projection lens system and project to a projection screen.

8. The single-imager micro projection engine according to claim 7, further comprising:
an imaging polarization beam splitter adapted to receive the first polarization portion of the collimated illumination beam and the converted second polarization portion from the planar polarization beam splitter, transmit the first polarization portion and the converted second polarization portion to the reflective polarization modulation imager, and reflect the modulated illumination of continued images in second polarization state from the reflective polarization modulation imager to the projection lens system.

9. The single-imager micro projection engine according to claim 8, wherein the reflective polarization modulation imager comprises a second transmissive quarter wave plate and a reflective intensity modulation imager panel.

10. The single-imager micro projection engine according to claim 9, wherein the reflective intensity modulation imager panel comprises a micro electrical-mechanical diffractive pixel array or a Galvanic light valve array in a regularly tiled planar arrangement.

11. The single-imager micro projection engine according to claim 8, wherein the reflective polarization modulation imager is a liquid crystal on silicon imager.

12. The single-imager micro projection engine according to claim 8, further comprising means for adjusting and balancing the first polarization portion and the converted second polarization portion received by the reflective polarization modulation imager.

13. The single-imager micro projection engine according to claim 12, wherein the means is adapted to electrically instruct the reflective polarization modulation imager upon measuring and calibrating, to adjust and balance reflected light outputs between the first half facing area receiving the first polarization portion and the second half facing area receiving the converted second polarization portion.

14. The single-imager micro projection engine according to claim 13, wherein the means is adapted to apply optical compensation to the first half facing area.

15. The single-imager micro projection engine according to claim 14, wherein the means is adapted to reduce intensity of the first polarization portion before applying the optical compensation to the first half facing area.
